(19) United States
(12) Patent Application Publication
(10) Pub. No.: US 2010/0080331 A1
(43) Pub. Date: Apr. 1, 2010

(54) METHOD AND APPARATUS FOR INTEGRATED CLOCK MISMATCH COMPENSATION AND PACKET LOSS CONCEALMENT

(75) Inventors: Harinath Garudadri, San Diego, CA (US); Rouzbeh Kashef, La Jolla, CA (US); Somdeb Majumdar, San Diego, CA (US); Chinnappa K. Ganapathy, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/365,357

(22) Filed: Feb. 4, 2009

Related U.S. Application Data
(60) Provisional application No. 61/100,661, filed on Sep. 26, 2008.

(51) Int. Cl. H04L 7/00

(52) U.S. Cl. 375/354

(57) ABSTRACT

An apparatus and method for processing data are disclosed. The apparatus may include a receiver clock, and a processing system configured to use the receiver clock to receive data from a transmitter, the data being generated with a transmitter clock in the transmitter, wherein the processing system is further configured to estimate a mismatch between the transmitter and receiver clocks, and to determine whether to modify the data based on the estimated mismatch.

### CLAIM FOR PRIORITY UNDER 35 U.S.C. §119

This application claims the benefit of and priority to commonly owned U.S. Provisional Patent Application No. 61/100,661, filed Sep. 26, 2008, and assigned Attorney Docket No. 081459P1, the disclosure of which is hereby incorporated by reference herein.

### BACKGROUND

1. Field

This application relates generally to data processing and more specifically, but not exclusively, to detecting and concealing data errors and data synchronization.

2. Introduction

In a data communication system, data may be sent from one device to another device over a designated communication medium. Here, the device that sends the data (e.g., a source device) may generate the data based on a transmit clock. In some systems, the source device sends the data without sending the transmit clock signal. In such a case, the device that receives the data (e.g., a destination device) may use its own receive clock to process the received data. In cases where the receive clock and the transmit clock are not synchronized, however, there may be a timing mismatch between the rate at which the source device sends the data and the rate at which the destination device processes the received data.

A timing mismatch such as this may lead to errors in the received data. For example, the received data may be stored in a buffer at the destination device and read out of the buffer using the receive clock. If the receive clock lags (e.g., is slower than) the transmit clock, a buffer overflow condition may occur at the destination device. Conversely, if the receive clock leads (e.g., is faster than) the transmit clock, a buffer underflow condition may occur at the receiver. For certain types of data (e.g., streaming audio), data errors caused by such data over-runs or under-runs may cause distortion in an output signal (e.g., an audio signal) generated from the received data.

One technique for addressing a timing mismatch problem is making the transmit clock available to the destination device in some manner (e.g., directly or via the data stream). In this case, the destination device uses the transmit clock or a clock that is synchronized to the transmit clock to process received data. In practice, however, such a technique may be relatively complex to implement. Such a technique may be even more complex in cases where the destination device receives data from multiple sources (e.g., each of which has its own transmit clock). The complexity associated with this technique may thus make it undesirable for some applications due to, for example, a resulting increase in hardware cost and, in some cases, reduction in battery life.

Another technique for addressing such a timing mismatch involves modifying the receive buffer using dynamic time-warping. Time-warping involves modifying the size of the buffer by upsampling and downsampling the received samples to provide data at a desired data rate. However, time-warping involves spectral domain processing or autocorrelation methods in the time domain. As these processes are computationally expensive and result in additional data processing delays, time-warping may not be a practical solution for some applications.

In addition to the timing mismatch, data may be corrupted in some manner when it is transferred between the devices. For example, data may be corrupted when it is written into or read out of a storage medium or when it is transmitted through a communication medium. As a result, the data a device receives from another device may include one or more errors. For example, a bit in a block of pulse code modulation (“PCM”) data that was transmitted by a transmitting component as a “0” (or “−1”) may be received at a receiving component as a “1” due to interference along the data transmission path. Errors in the encoded data stream arising from transmission and/or retrieval of such data may result in artifacts in the audio output (e.g., perceived “clicks and pops”).

Various techniques may be used to handle errors in received data. For example, upon receipt of a data stream a receiving device may convert the received data into representative PCM data (sampled at the Nyquist frequency) and process the PCM data to determine whether there is an error in the data. In some cases, a receiving device may request that a transmitting device resend any data that is received with one or more errors. In some cases, a receiving device may perform some type of post-processing on the PCM data to correct the errors. For example, in cases where the PCM data represents a waveform (e.g., an audio signal), the receiving device may employ filtering operations that process a relatively large portion of the waveform data (e.g., process the PCM data that precedes and follows one or more corrupted data bits in time) to correct the error.

Error processing schemes such as those discussed above may have several drawbacks. For example, data retransmissions may result in an increase in data processing latency, an increase in processing load, and an increase in traffic over the data transmission path. Similarly, post-processing operations may result in an increase in data processing latency and may involve complex, power-hungry signal processing operations.

Consequently, there exists a need for an adaptive, low latency, unified approach to solving transmit and receive clock mismatch between communication nodes as well as process errors.

### SUMMARY

According to an aspect of the disclosure, an apparatus for processing data includes a receiver clock, and a processing system configured to use the receiver clock to receive data from a transmitter, the data being generated with a transmitter clock in the transmitter, wherein the processing system is further configured to estimate a mismatch between the transmitter and receiver clocks, and to determine whether to modify the data based on the estimated mismatch.

According to another aspect of the disclosure, an apparatus for processing data includes a receiver clock, and a processing system configured to use the receiver clock to receive data from a transmitter, the data being generated with a transmitter clock in the transmitter, wherein the processing system is further configured to estimate a mismatch between the transmitter and receiver clocks, determine a concealment length for a portion of the data based on a decoding error, and change the concealment length if the estimated clock mismatch satisfies one or more criteria.

According to a further aspect of the disclosure, a method for processing data includes receiving data from a transmitter by utilizing a receiver clock, the data being generated with a transmitter clock in the transmitter, estimating a mismatch between the transmitter and receiver clocks, and determining whether to modify the data based on the estimated mismatch.

According to yet a further aspect of the disclosure, a method for processing data includes receiving data from a transmitter by utilizing a receiver clock, the data being generated with a transmitter clock in the transmitter, estimating a mismatch between the transmitter and receiver clocks, determining a concealment length for a portion of the data based on a decoding error, and changing the concealment length if the estimated clock mismatch satisfies one or more criteria.

According to yet a further aspect of the disclosure, an apparatus for processing data includes means for receiving data from a transmitter by utilizing a receiver clock, the data being generated with a transmitter clock in the transmitter, means for estimating a mismatch between the transmitter and receiver clocks, and means for determining whether to modify the data based on the estimated mismatch.

According to yet a further aspect of the disclosure, an apparatus for processing data includes means for receiving data from a transmitter by utilizing a receiver clock, the data being generated with a transmitter clock in the transmitter, means for estimating a mismatch between the transmitter and receiver clocks, means for determining a concealment length for a portion of the data based on a decoding error, and means for changing the concealment length if the estimated clock mismatch satisfies one or more criteria.

According to yet a further aspect of the disclosure, a computer program product for processing data includes a computer-readable medium encoded with instructions executable to receive data from a transmitter by utilizing a receiver clock, the data being generated with a transmitter clock in the transmitter, estimate a mismatch between the transmitter and receiver clocks, and determine whether to modify the data based on the estimated mismatch.

According to yet a further aspect of the disclosure, a computer program product for processing data includes a computer-readable medium encoded with instructions executable to receive data from a transmitter by utilizing a receiver clock, the data being generated with a transmitter clock in the transmitter, estimate a mismatch between the transmitter and receiver clocks, determine a concealment length for a portion of the data based on a decoding error, and change the concealment length if the estimated clock mismatch satisfies one or more criteria.

According to yet another aspect of the disclosure, a headset includes a receiver clock, a processing system configured to use the receiver clock to receive data from a transmitter, the data being generated with a transmitter clock in the transmitter, wherein the processing system is further configured to estimate a mismatch between the transmitter and receiver clocks, and to determine whether to modify the data based on the estimated mismatch, and a transducer configured to provide an audible output based on the data.

According to yet another aspect of the disclosure, a headset includes a receiver clock, a processing system configured to use the receiver clock to receive data from a transmitter, the data being generated with a transmitter clock in the transmitter, wherein the processing system is further configured to estimate a mismatch between the transmitter and receiver clocks, determine a concealment length for a portion of the data based on a decoding error, and change the concealment length if the estimated clock mismatch satisfies one or more criteria, and a transducer configured to provide an audible output based on the data.

According to yet another aspect of the disclosure, a watch includes a receiver clock, and a processing system configured to use the receiver clock to receive data from a transmitter, the data being generated with a transmitter clock in the transmitter, wherein the processing system is further configured to estimate a mismatch between the transmitter and receiver clocks, and to determine whether to modify the data based on the estimated mismatch, and a display configured to provide a visual output based on the data.

According to yet another aspect of the disclosure, a watch includes a receiver clock, a processing system configured to use the receiver clock to receive data from a transmitter, the data being generated with a transmitter clock in the transmitter, wherein the processing system is further configured to estimate a mismatch between the transmitter and receiver clocks, determine a concealment length for a portion of the data based on a decoding error, and change the concealment length if the estimated clock mismatch satisfies one or more criteria, and a user interface configured to provide an indication based on the data.

According to yet a further aspect of the disclosure, a medical monitor includes a receiver clock, and a processing system configured to use the receiver clock to receive data from a sensor, the data being generated with a transmitter clock in the sensor, wherein the processing system is further configured to estimate a mismatch between the sensor and receiver clocks, and to determine whether to modify the data based on the estimated mismatch, a display configured to provide a visual output based on the data.

According to yet a further aspect of the disclosure, a medical monitor includes a receiver clock, a processing system configured to use the receiver clock to receive data from a sensor, the data being generated with a transmitter clock in the sensor, wherein the processing system is further configured to estimate a mismatch between the transmitter and receiver clocks, determine a concealment length for a portion of the data based on a decoding error, and change the concealment length if the estimated clock mismatch satisfies one or more criteria, and a display configured to provide a visual output based on the data.

It is understood that other aspects of the invention will become readily apparent to those skilled in the art from the following detailed description, wherein it is shown and described only various aspects of the invention by way of illustration. As will be realized, the invention is capable of other and different aspects and its several details are capable of modification in various other respects, all without departing from the scope of the invention. Accordingly, the drawings and detailed description are to be regarded as illustrative in nature and not as restrictive.

### BRIEF DESCRIPTION OF THE DRAWINGS

These and other sample aspects of the disclosure will be described in the detailed description and the appended claims that follow, and in the accompanying drawings, wherein:

FIG. 1 is a conceptual diagram illustrating an example of a wireless communications system;

FIG. 2 is a simplified block diagram illustrating an example of a receiver;

FIG. 3 is a simplified block diagram illustrating an example of an integrated clock mismatch and packet loss concealment (ICPC) circuit;

FIG. 4 is a simplified block diagram illustrating an example of a token bucket controller;

FIG. 5 is a graph illustrating an example of a relationship between token bucket leakage versus occupancy;

FIG. 6 is a flowchart depicting an example of an integrated clock mismatch compensation and packet loss concealment process in a receiver;

FIG. 7 is a block diagram illustrating an example of the functionality of an apparatus; and

FIG. 8 is a block diagram illustrating an example of the functionality of another apparatus.

In accordance with common practice the various features illustrated in the drawings may be simplified for clarity. Thus, the drawings may not depict all of the components of a given apparatus (e.g., node) or method. In addition, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. An aspect may comprise one or more elements of a claim.

Several aspects of a receiver will now be presented. The receiver may be part of a mobile or fixed node, such as a phone (e.g., cellular phone), a personal digital assistant (PDA), an entertainment device (e.g., a music or video device), a headset (e.g., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), a medical monitor that may receive data from the medical sensing device, an environment sensing device (e.g., a tire pressure monitor), a computer, a point-of-sale device, an entertainment device, a hearing aid, a set-top box, or any other suitable device. The node may include various components in addition to the receiver. By way of example, a wireless headset may include a transducer configured to provide an audio output to a user, a wireless sensing device may include a sensor configured to provide an audio output to a user, and a wireless watch may include a user interface configured to provide an indication to a user. The indication may be audible, visual, and/or mechanical (e.g., vibration).

The receiver may also be part of an access device (e.g., a Wi-Fi access point) that provides backhaul services to other nodes. Such an access device may provide, by way of example, connectivity to another network (e.g., a wide area network such as the Internet or a cellular network) via a wired or wireless communication link.

In many of the applications described above, the receiver may be part of a node that transmits as well as receives. Such a node would therefore require a transmitter, which may be a separate component or integrated with the receiver into a single component known as a “transceiver.” As those skilled in the art will readily appreciate, the various concepts described throughout this disclosure are applicable to any suitable receiver function, regardless of whether the receiver is a stand-alone node, integrated into a transceiver, or part of a node in a wireless communications system.

In the following detailed description, various aspects of a receiver will be described for reducing or removing signal artifacts (e.g., audio artifacts) from received signals. Some aspects of the receiver will be described in the context of a WPAN supporting Ultra-Wideband (UWB), but as those skilled in the art will readily appreciate that the various aspects presented throughout this disclosure are likewise applicable to receivers for other radio technologies including Bluetooth, WiMax, and Wi-Fi, just to name a few. These aspects may also be extended to wired technologies including, by way of example, cable modem, Digital Subscriber Line, (DSL), Ethernet, and any other suitable communications technology.

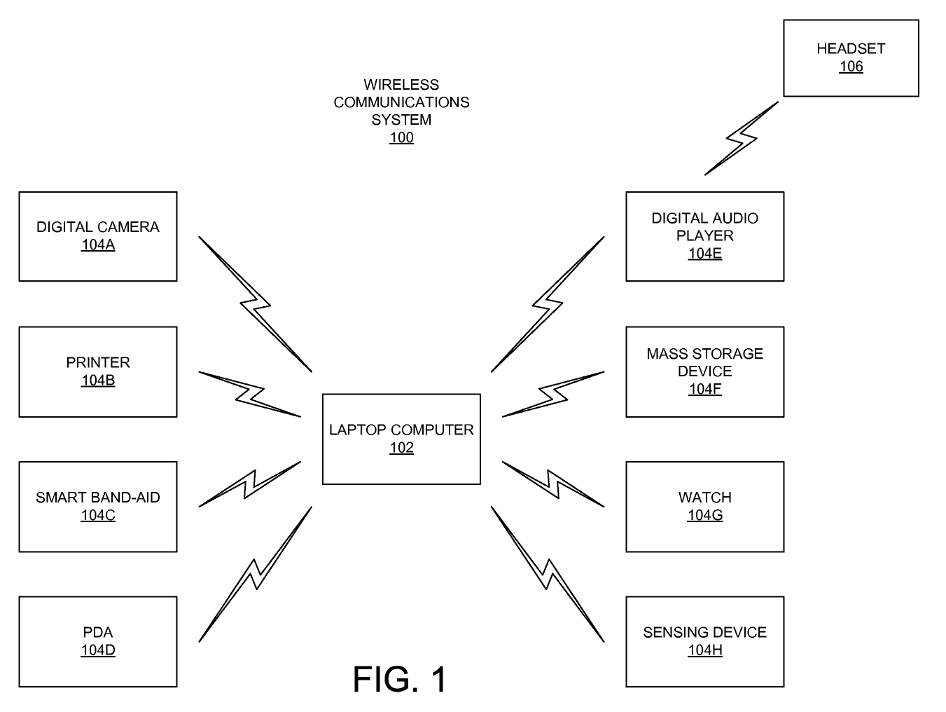

An example of a UWB WPAN with wireless nodes that may benefit by incorporating various aspects of a receiver presented throughout this disclosure is shown in FIG. 1. UWB is a common technology for high speed short range communications (e.g., home and office networking applications) as well as low speed long range communications. UWB is defined as any radio technology having a spectrum that occupies a bandwidth greater than 20 percent of the center frequency, or a bandwidth of at least 500 MHz. Two radio technologies have recently emerged to support UWB. One is based on Impulse Radio techniques extended to direct sequence spread spectrum. The other radio technology is based on Orthogonal Frequency Division Multiplexing (OFDM).

The WPAN 100 is shown with a laptop computer 102 in communication with various other wireless nodes 104. In this example, the computer 102 may receive digital photos from a digital camera 104A, send documents to a printer 104B for printing, communicate with a smart band-aid 104C, synch-up with e-mail on a Personal Digital Assistant (PDA) 104D, transfer music files to a digital audio player (e.g., MP3 player) 104E, back up data and files to a mass storage device 104F, set the time on a watch 104G, and receive data from a sensing device 104H (e.g., a medical device such as a biometric sensor, a heart rate monitor, a pedometer, an EKG device, etc.). Also shown is a headset 106 (e.g., headphones, earpiece, etc.) that receives audio from the digital audio player 104E.

In one configuration of the WPAN 100, the computer 102 provides an access point to a Wide Area Network (WAN) (i.e., a wireless network covering a regional, nationwide, or even a global region). One common example of a WAN is the Internet. Another example of a WAN is a cellular network that supports CDMA2000, a telecommunications standard that uses Code Division Multiple Access (CDMA) to send voice, data, and signaling between mobile subscribers. Another example of a WWAN is a cellular network that provides broadband Internet access to mobile subscribers, such as Evolution-Data Optimized (EV-DO) or Ultra Mobile Broadband (UMB), both of which are part of the CDMA2000 family of air interface standards. Alternatively, or in addition to, the computer 102 may have a UWB connection to an Ethernet modem, or some other interface to a Local Area Network (LAN) (i.e., a network generally covering tens to a few hundred meters in homes, offices buildings, coffee shops, transportation hubs, hotels, etc.).

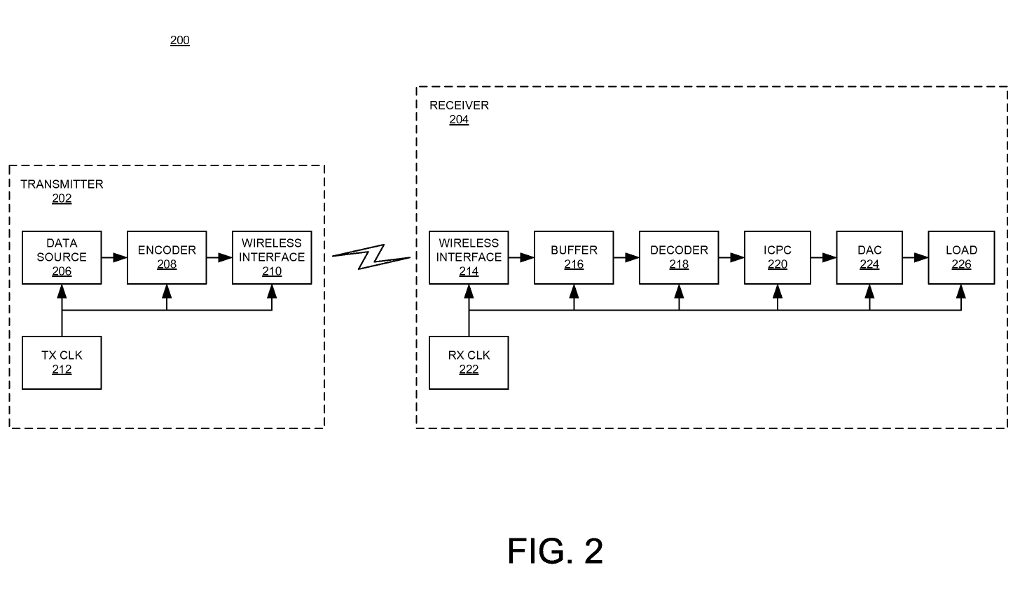

Various aspects of a receiver will now be presented with reference to FIG. 2. As discussed earlier, these aspects may be well suited for wireless nodes in a UWB WPAN such as the one described in connection with FIG. 1. However, as those skilled in the art will readily appreciate, these aspects may be extended to receivers for other radio and wired technologies.

FIG. 2 is a schematic block diagram illustrating an example of a transmitter 202 and a receiver 204 in a communications system 200. The transmitter 202 is shown with a data source 206, encoder 208, and a wireless interface 210, all clocked by a TX clock 212.

The encoder 208 receives data from the data source 206. The data may be audio, video, text, and/or other types of multimedia content. In the case of audio, the encoder 208 may be configured to encode the audio signal to a particular audio file format or streaming audio format. In one example of a transmitter 202, the encoder 208 may encode the audio signal using a backward adaptive gain ranged algorithm; however, the encoder 208 may be configured to provide other encoding schemes.

The encoded audio signal may be provided to a wireless interface receiver 210 that implements the physical (PHY) layer and the Medium Access Control (MAC) layer. The PHY layer implements all the physical and electrical specifications to interface the transmitter 202 to the wireless medium. More specifically, the PHY layer is responsible for modulating a carrier with the encoded audio signal, as well as providing other processing functions such as forward error correction (e.g., Turbo coding). The MAC layer manages the data that is transmitted across the PHY layer making it possible for the transmitter to communicate with several nodes.

At the receiver 204, the modulated carrier signal is processed by a wireless interface 214. The wireless interface 214 is similar to that described in connection with transmitter 202, implementing both the PHY and MAC layers. The PHY layer, which implements all the physical and electrical specifications to interface the receiver to the wireless medium, demodulates the carrier to recover an audio signal and provides other processing functions such as timing and frequency estimation, channel estimation, and forward error correction (e.g., Turbo decoding). The PHY layer may also provide analog-to-digital conversion providing “encoded audio signal samples” at the output. The MAC layer manages the audio content that is received across the PHY layer making it possible for several nodes to communicate with the receiver 204. The implementation of the wireless interface 204 is well within the capabilities of one skilled in the art, and therefore, will not be described any further.

The encoded audio signal samples output from the wireless interface 214 are provided to a buffer 216 prior to decoding. The buffer 216 temporarily stores the encoded audio signal samples to attempt to compensate for a difference between respective data flow rates of the transmitter 202 and the receiver 204. The buffer 216 collects the encoded audio signal samples and provides them to a decoder 218 to reconstruct the audio signal from the encoded transmission recovered by the wireless interface 214. The decoder 218 may be configured to reconstruct an audio signal encoded with a backward adaptive gain ranged algorithm to support the configuration of the transmitter 202 described earlier, or may be configured to handle other encoding schemes. Those skilled in the art will be readily able to implement the appropriate decoder 218 for any particular application. The decoder 218 may be a stand-alone component as shown in FIG. 2, or integrated into an audio codec in the case where the receiver 204 is part of a node that transmits as well as receives.

The output from the decoder 218 may be provided to an integrated clock mismatch and packet loss concealment (ICPC) circuit 220. The ICPC circuit 220 provides an integrated solution for concealing artifacts in a reconstructed signal arising from clock mismatch and signal errors. In case of clock mismatch, the ICPC circuit 220 is configured to delete or insert samples into the received signal when the buffer is in an overflow condition or an underflow condition, respectively; and in case of a detected error or loss in a signal sample, the ICPC circuit 220 is configured to conceal the error or loss by replacing corrupted or lost samples with more or fewer modified samples. The ICPC circuit 220 may derive the substitute modified samples from neighboring samples that are not corrupted.

The output from the ICPC circuit 220 may be provided to a digital-to-analog converter (DAC) 224, which converts the output to an analog signal in order to drive the load 226 (e.g., a speaker).

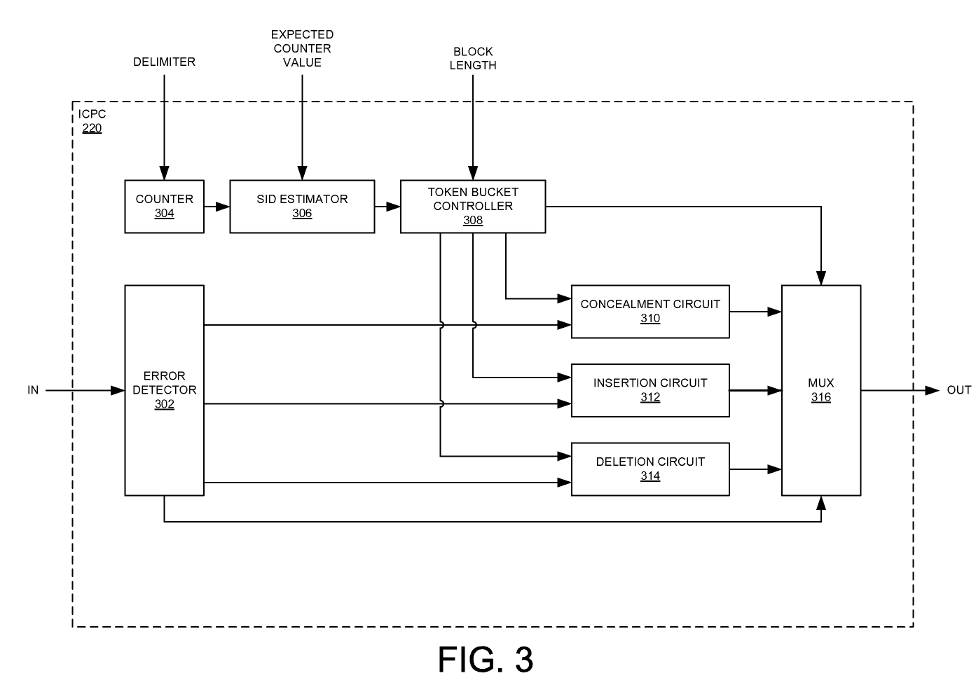

FIG. 3 is a simplified block diagram illustrating an example of the ICPC circuit 220. As shown in FIG. 3, the ICPC circuit 220 may include an error detector 302, a counter 304, a sample insertion/deletion (SID) estimator 306, a token bucket controller 308, a concealment circuit 310, an insertion circuit 312, a deletion circuit 314, and a multiplexer 316.

The error detector 302 may receive the signal outputted from the decoder 218 of FIG. 2. The signal received by the error decoder 302 may be received in blocks of decoded data samples. For each block, the error detector 302 is configured to determine whether any of the samples in the block include an error or are missing. Such error detection may be performed using some error detection methodology, such as cyclic redundancy check (CRC), or any other suitable methodology. If the error detector 302 detects an error or a missing sample, it is configured to flag the block as being corrupt. Flagging the block in this manner indicates to the concealment circuit 310 that the corrupt block needs to be concealed. On the other hand, if the error detector 302 does not detect any error within the block, it does not flag the block. In either case the error detector 302 transmits the flagged and unflagged blocks to the concealment circuit 310, the insertion circuit 312, and the deletion circuit 314 for further processing.

The counter 304, SID estimator 306, and token bucket controller 308 are configured to determine when a sample needs to be either deleted from or inserted into a data block. In particular, the counter 304 may receive a delimiter position of each received packet from the MAC layer. A delimiter position is typically used to mark the arrival of a packet. The counter 304 counts the number of clock cycles of the receive clock 222 (see FIG. 2) between adjacent delimiters, generates an actual counter value based on the counted number of clock cycles, and transmits this actual counter value to the SID estimator 306. In addition to the actual counter value, the SID estimator 306 also receives an expected counter value, which represents the expected number of clock cycles between received adjacent delimiters. The expected counter value may be transmitted to the SID estimator 306 via the MAC layer. When there exists a timing mismatch between the transmit clock 212 and the receive clock 222, the data packets arrive at the receiver 204 either too quickly or too slowly, resulting in a buffer overflow condition or underflow condition, respectively. The SID estimator 306 is configured to compare the expected counter value with the actual counter value, and based on the comparison, generates a sample insert/delete (SID) signal for transmission to the token bucket controller 308. The SID signal may be in the form of a negative token or a positive token. The SID estimator 306 generates a negative token when the expected counter value is greater than the actual counter value; and generates a positive token when the expected counter value is less than the actual counter value.

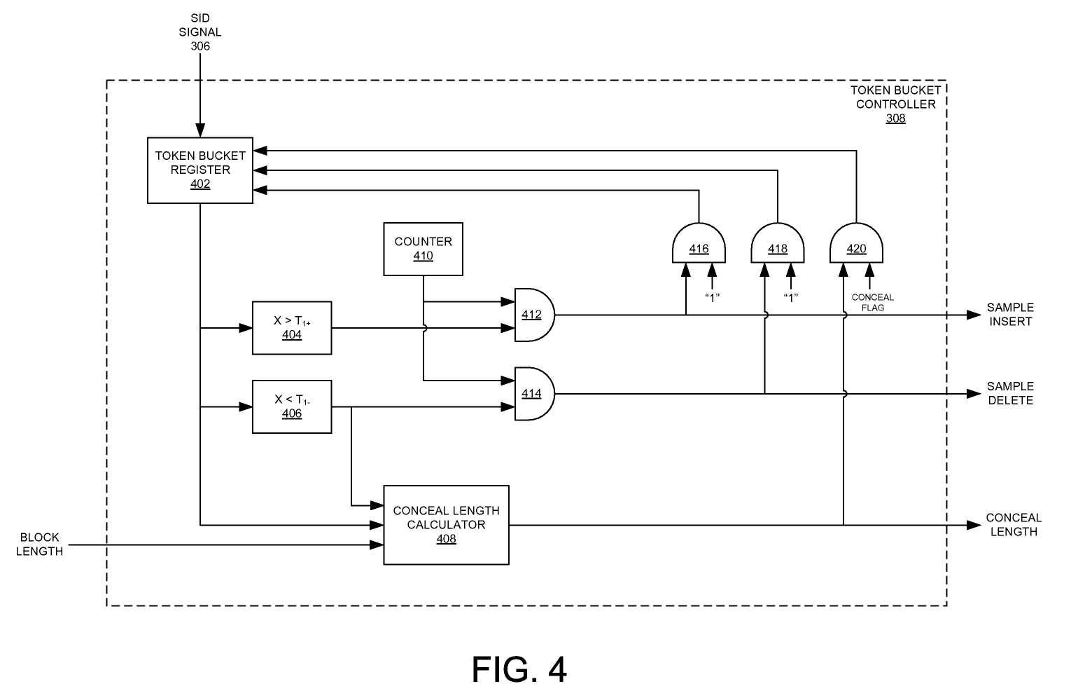

The token bucket controller 308 receives the SID signal from the SID estimator 306 and a block length signal from the MAC layer, and based on the SID signal and the block length signal controls the concealment circuit 310, the insertion circuit 312, and the deletion circuit 314. Specifically, the token bucket controller 308 accumulates and averages the negative and positive tokens received from the SID estimator. If the toke bucket controller 308 collects more negative tokens than positive tokens, then its occupancy will be negative. Conversely, if the toke bucket controller 308 collects more positive tokens than negative tokens, then its occupancy will be positive. A negative occupancy occurs when the receive clock is slower than the transmit clock; and a positive occupancy occurs when the receive clock is faster than the transmit clock. In either case, the token bucket controller 308 may generate an insert sample command signal for the insertion circuit 312 or a delete sample command signal for the deletion circuit 314 only after the receipt of N samples (e.g., 4096 samples) at the ICPC circuit 220. This duration may be programmable and may be tracked using a counter, as discussed with reference to FIG. 4.

FIG. 4 is a simplified block diagram illustrating an example of the token bucket controller 308. As shown in FIG. 4, the token bucket controller 308 may include a token bucket register 402. It is in this register 402 that the token bucket controller 308 maintains the occupancy status by averaging the negative and positive tokens received via the SID signal from the SID estimator 306.

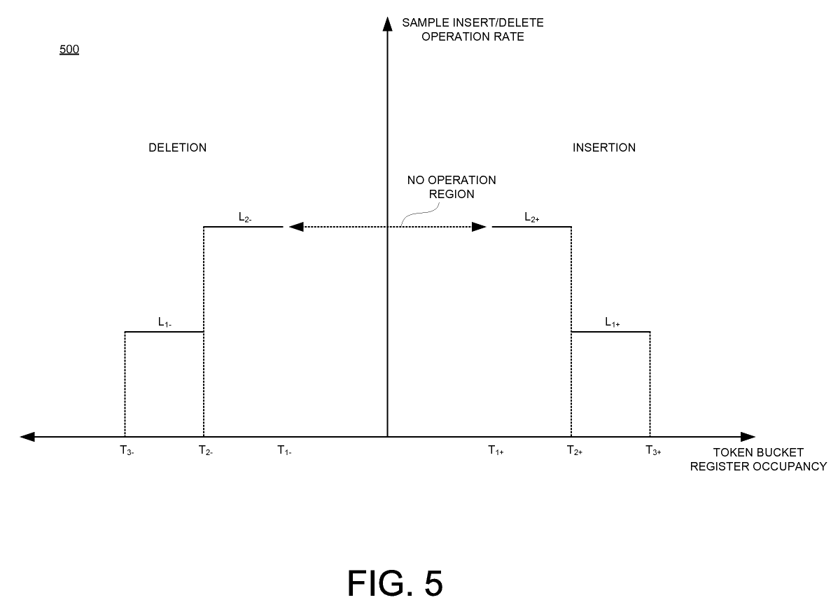

It should be noted that positive and negative tokens may be input into the token bucket register 402 in a slightly erratic alternating manner due to inherent jitter in the mismatch of the transmit and receive clocks. In general, this jitter averages out over time. However, to ensure that the token bucket controller 308 does not react to the low jitter of the clock mismatch, the sample deletion and insertion operations are not performed as long as the token bucket occupancy is maintained within occupancy thresholds T₁₊ and T₁₋ for insertion and deletion, respectively. This concept may be better illustrated with reference to FIG. 5.

FIG. 5 is a graph illustrating an example of a relationship between sample insert/delete operation rate versus occupancy. As shown in FIG. 5, the x-axis of the graph represents the token bucket register occupancy, and the y-axis represents the sample insert/delete operation rate. From the graph, it is evident that when the occupancy of the token bucket register 402 is between the occupancy thresholds T₁₊ and T₁₋, no sample insert/delete operations are performed. T₁₊ and T₁₋ may, for example, each represent of a number of samples (e.g., 3 samples) worth of positive and negative tokens, respectively. It is also evident from the graph that when the occupancy of the token bucket register 402 is between T₁₊ and T₂₊, the sample insert/delete operation rate is at L₂₊. Accordingly, by preventing sample insert/delete operations during low occupancy, the token bucket controller 308 may ensure that the sample insert/delete operations are not performed too aggressively or too conservatively.

Returning to FIG. 4, it should be noted that every N samples, the token bucket controller 308 inspects the occupancy status of the token bucket register 402 to determine whether the occupancy is positive and has exceeded the positive T₁₊ threshold or negative and has exceeded the negative T₁₋ threshold.

For example, as shown in FIG. 4, the token bucket register 402 transmits its occupancy status to comparison circuit 404 and comparison circuit 406 to determine if the occupancy (denoted as “x”) has exceeded the T₁₊ threshold or the T₁₋ threshold, respectively. If the occupancy has exceeded the T₁₊ threshold the comparison circuit 404 transmits a logic “1” to AND gate 412. Likewise, if the occupancy has exceeded the T₁₋ threshold the comparison circuit 406 transmits a logic “1” to AND gate 414. AND gates 412 and 414, however, will not transmit the sample insert or sample delete command signal unless counter 410 has reached a particular value. For example, counter 410 may maintain track of every received sample and transmit a logic “1” to the AND gates 412 and 414 only every N samples (e.g., 4096). Once the AND gates 412 and 414 receive the logic “1” from the counter 410, they would be able to transmit the sample insert or sample delete command signal, respectively, if the occupancy has exceeded the T₁₊ threshold or the T₁₋ threshold. In this manner, the token bucket controller 308 may control how often the ICPC 220 performs sample insert/delete operations.

Consequently, if the occupancy is positive and exceeds the positive T₁₊ threshold, the token bucket controller 308 generates and transmits the insert sample command signal to the insertion circuit 312. If the occupancy is negative and exceeds the negative T₁₋ threshold, the token bucket controller 308 generates and transmits the delete sample command signal to the deletion circuit 314.

Upon receipt of the insert sample command signal the insertion circuit 312 may identify an insertion location in the block of data samples received from the error detector 302, generate an insertion sample based on preceding and following samples in the block, and insert the generated sample. The generated sample may, for example, be a calculated average signal value of the preceding and following samples. After inserting the sample, the insertion circuit 312 may transmit the altered block of samples to the multiplexer 316. The multiplexer 316 may be triggered by the token bucket controller 308 to select the output of the insertion circuit 312 and transmit the altered block of samples to the DAC 224.

Upon receipt of the delete sample command signal the deletion circuit 314 may identify a sample to delete in the block of data samples received from the error detector 302, and delete the identified sample. After deleting the sample, the deletion circuit 314 may transmit the altered block of samples to the multiplexer 316. The multiplexer 316 may be triggered by the token bucket controller 308 to select the output of the deletion circuit 314 and transmit the altered block of samples to the DAC 224.

It should be noted that, whenever a sample deletion or sample insertion operation is performed, the occupancy in the token bucket register 402 is adjusted accordingly. For example, if AND gate 412 is triggered to pass a sample insert command signal, logic AND gate 416 will send a decrement positive token signal to the token bucket register 402 to adjust the occupancy. Similarly, if AND gate 414 is triggered to pass a sample delete command signal, logic AND gate 418 will send a decrement negative token signal to the token bucket register 402 to adjust the occupancy.

Apart from performing sample insertion/deletion operations, the ICPC 220 also allows for control of the packet loss mitigation (e.g., concealment). The required inputs for this operation are a conceal flag signal, supplied by the error detector 304 to AND gate 420; block length signal, supplied by the MAC layer to a conceal length calculator 408; and the token bucket occupancy signal, supplied by the token bucket register 402 to the conceal length calculator 408.

When the error detector 304 detects an error in a data block, the error detector 304 prevents the corrupted block from being transmitted out of the ICPC 220 by restricting data flow through the multiplexer 316. The conceal length calculator 408 proceeds to generate a concealment vector based on the blocks adjacent to the corrupted block. The length of the concealment vector is derived via the following equation (1).

Conceal Length=L+max(min(x, 0), xMax)=L−ΔL (1)

In the above equation (1), L is the length of the block to be concealed; x is the token bucket occupancy; xMax is less than 0; and ΔL represents the number of pending deletions (i.e., number of negative tokens exceeding the T₁₋ threshold) as derived from the token bucket register 402.

At the end of the concealment process, the token bucket register 402 is incremented by ΔL to denote that ΔL pending deletions have been accounted for. That is, at the point of packet loss concealment, if there is a net negative token bucket occupancy, it implies that there are outstanding sample deletions to be performed in the future. Instead of performing deletions in the usual manner, the outstanding deletions (up to |xMax| samples) are “absorbed” during concealment process.

Please consider the following examples to better illustrate the concealment operation.

### EXAMPLE 1

### L=330; x=−8; xMax=−16; and T₁₋=3

In the above example, it is implied that the current block of 330 samples needs to be concealed. The occupancy of the token bucket register 402 projects 8 future deletions. In this example, it may be assumed that the maximum number of future deletions that may be absorbed during a concealment process may be 16. It may also be assumed that deletions of up to 3 samples may be ignored, as 3 samples are within the occupancy threshold (i.e., only 8−3=5 samples need to be deleted).

Thus, Conceal Length=330−5=325. Accordingly, by generating only 325 samples instead of 330, 5 outstanding future deletions have been accounted for. As a result, the token bucket register 402 is simultaneously incremented by 5 via the AND gate 420 to reflect this fact.

### EXAMPLE 2

### L=330; x=−21; xMax=−16; and T₁₋=3

This situation implies that the current block of 330 samples needs to be concealed. The occupancy projects 18 future deletions. As in the above example, deletions of up to 3 samples may be ignored. That is, only 21−3=18 samples need be deleted. However, it may again be assumed that the maximum number of future deletions that may be absorbed during a concealment process is 16.

Thus, Conceal Length=330−16=314. As in the previous example, the occupancy of −21 is incremented by 16 via the AND gate 420, which results in x=−5. This simply means that there are 5 outstanding deletions in the token bucket register 402.

Since this operation results in deletions of more than one sample in a concealment block, it could lead to loss of quality if an unlimited number of future deletions are allowed to be absorbed. For this reason, |xMax| may be set to be less than 10% of the block length.

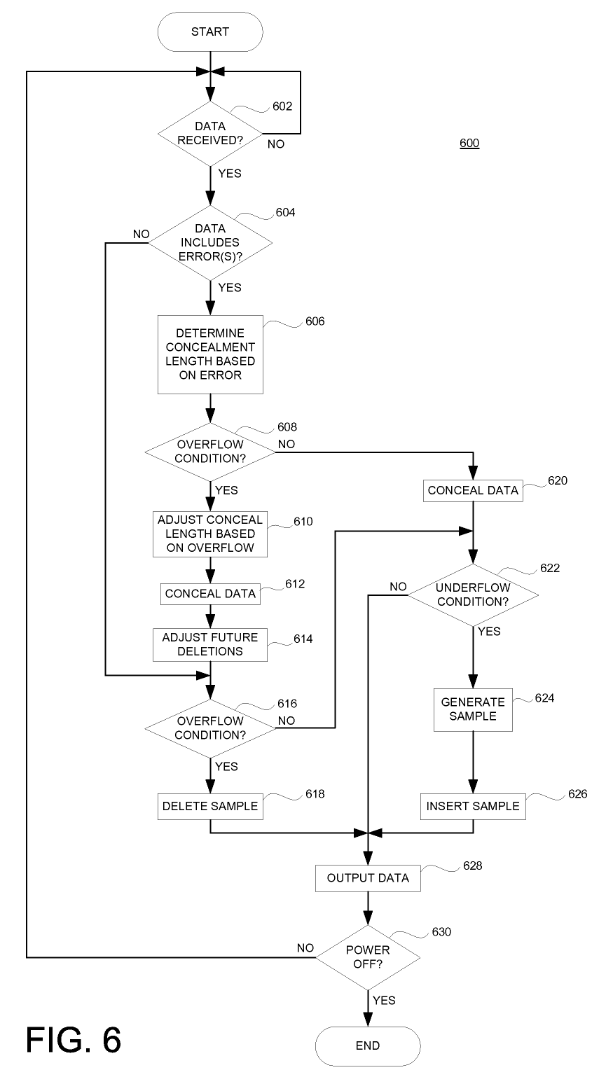

An example of an integrated clock mismatch compensation and packet loss concealment process used by the receiver 204 will now be described with respect to the flow chart illustrated in FIG. 6. As shown in FIG. 6, in block 602, a determination is made as to whether data (e.g., audio signal samples) are received at, for example, the buffer 216. If the data is received, the process proceeds to block 604, otherwise the process continues to check for received data at block 602.

In block 604, a determination is made as to whether the received data includes errors. If the data does include errors, the process proceeds to block 606. Otherwise, the process proceeds to block 616. In block 606, the process determines a concealment length based on the error, and the process proceeds to block 608.

In block 608, a determination is made as to whether an overflow condition exists. If an overflow condition exists, the process proceeds to block 610. Otherwise, the process proceeds to block 620. In block 610, the determined concealment length is adjusted based on the overflow (e.g., occupancy of token bucket register 402), and the process proceeds to block 612. In block 612, the process conceals data based on the adjusted conceal length, and the process proceeds to block 614. In block 614, the process adjusts future deletions (e.g., the occupancy of the token bucket register 402 is adjusted based on the adjustment to the conceal length calculated by the conceal length calculator 408), and the process proceeds to block 616.

In block 616, a determination is made as to whether an overflow condition exists. If an overflow condition exists, the process proceeds to block 618. Otherwise, the process proceeds to block 622. In block 618, a sample is deleted from a data block by the deletion circuit 314, for example, and the process proceeds to block 628. In block 620, the process conceals data based on the determined conceal length, and the process proceeds to block 622.

In block 622, a determination is made as to whether an underflow condition exists. If an underflow condition exists, the process proceeds to block 624. Otherwise, the process proceeds to block 628. In block 624, a sample is generated by the insertion circuit 312, for example, and the process proceeds to block 626. In block 626, a sample is inserted into a data block by the insertion circuit 312, for example, and the process proceeds to block 628. In block 628, the data is output by the ICPC 220, for example.

After block 628, the process proceeds to block 630 where a determination is made as to whether the receiver 204 is powered off. If the receiver 204 is not powered off, the process returns to block 602. Otherwise, the process ends.

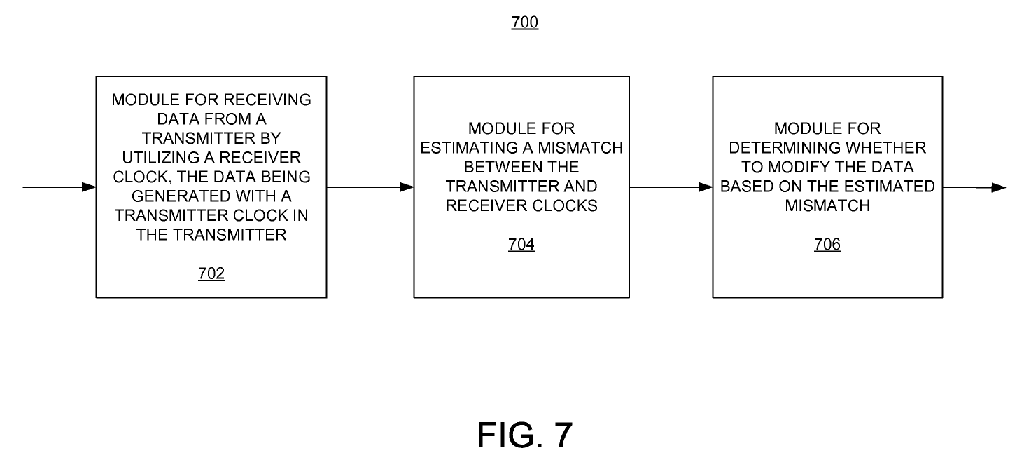

FIG. 7 is a block diagram illustrating an example of the functionality of an apparatus. In this example, the apparatus 700 includes a module 702 for receiving data from a transmitter by utilizing a receiver clock, the data being generated with a transmitter clock in the transmitter; a module 704 for estimating a mismatch between the transmitter and receiver clocks; and a module 706 for determining whether to modify the data based on the estimated mismatch. The module 702 may be implemented by the wireless interface 214 (see FIG. 2) described above or by some other suitable means. The modules 704 and 706 may be implemented at least by the ICPC circuit 220 described above or by some other suitable means.

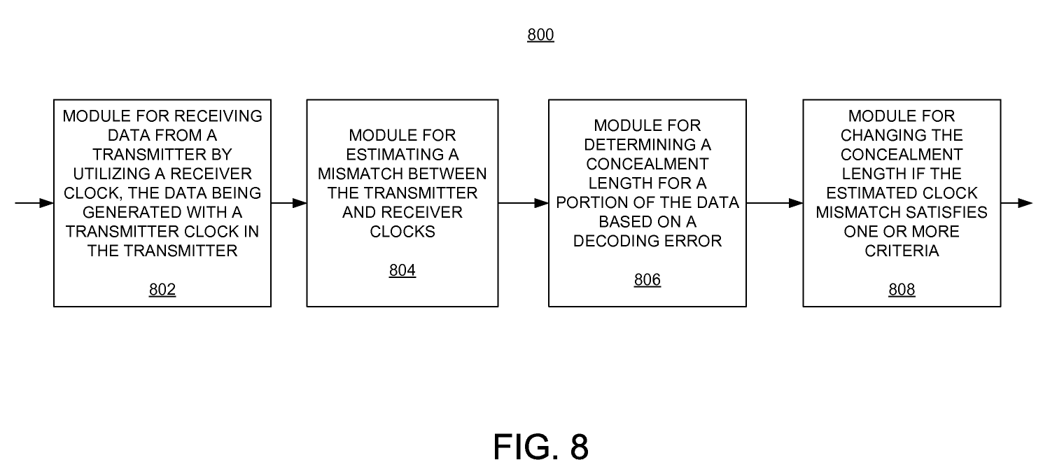

FIG. 8 is a block diagram illustrating an example of the functionality of an apparatus. In this example, the apparatus 800 includes a module 802 for receiving data from a transmitter by utilizing a receiver clock, the data being generated with a transmitter clock in the transmitter; a module 804 for estimating a mismatch between the transmitter and receiver clocks; a module 806 for determining a concealment length for a portion of the data based on a decoding error; and a module 808 for changing the concealment length if the estimated clock mismatch satisfies one or more criteria. The module 802 may be implemented by the wireless interface 214 (see FIG. 2) described above or by some other suitable means. The modules 704, 706, and 708 may be implemented at least by the ICPC circuit 220 described above or by some other suitable means.

The components described herein may be implemented in a variety of ways. For example, an apparatus may be represented as a series of interrelated functional blocks that may represent functions implemented by, for example, one or more integrated circuits (e.g., an ASIC) or may be implemented in some other manner as taught herein. As discussed herein, an integrated circuit may include a processor, software, other components, or some combination thereof Such an apparatus may include one or more modules that may perform one or more of the functions described above with regard to various figures.

As noted above, in some aspects these components may be implemented via appropriate processor components. These processor components may in some aspects be implemented, at least in part, using structure as taught herein. In some aspects a processor may be adapted to implement a portion or all of the functionality of one or more of these components.

As noted above, an apparatus may comprise one or more integrated circuits. For example, in some aspects a single integrated circuit may implement the functionality of one or more of the illustrated components, while in other aspects more than one integrated circuit may implement the functionality of one or more of the illustrated components.

In addition, the components and functions described herein may be implemented using any suitable means. Such means also may be implemented, at least in part, using corresponding structure as taught herein. For example, the components described above may be implemented in an “ASIC” and also may correspond to similarly designated “means for” functionality. Thus, in some aspects one or more of such means may be implemented using one or more of processor components, integrated circuits, or other suitable structure as taught herein.

Also, it should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination thereof.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for processing data, comprising:
a receiver clock; and
a processing system configured to use the receiver clock to receive data from a transmitter, the data being generated with a transmitter clock in the transmitter, wherein the processing system is further configured to estimate a mismatch between the transmitter and receiver clocks, and to determine whether to modify the data based on the estimated mismatch.

2. The apparatus of claim 1 wherein the processing system is further configured to determine a concealment length for a portion of the data based on a decoding error, the processing system being further configured to change the concealment length if the estimated clock mismatch satisfies one or more criteria.

3. The apparatus of claim 1 wherein the processing system is further configured to modify the data by inserting additional data if the estimated mismatch satisfies one or more criteria including an indication that the receiver clock is faster than the transmitter clock.

4. The apparatus of claim 1 wherein the processing system is further configured to modify the data by deleting a portion of the data if the estimated mismatch satisfies one or more criteria including an indication that the transmitter clock is faster than the receiver clock.

5. The apparatus of claim 1 wherein the processing system is further configured to modify the data if the estimated mismatch exceeds a threshold.

6. The apparatus of claim 1 wherein the data comprises one or more blocks of samples, the processing system being further configured to estimate the mismatch by computing a difference between the number of receiver clock cycles and an expected number of receiver clock cycles for each of the one or more blocks, and accumulating the computed differences.

7. The apparatus of claim 6 wherein the processing system is further configured to determine a concealment length for a portion of the data based on a decoding error, the processing system being further configured to change the concealment length if the accumulation of the differences exceeds a threshold and indicates that the transmitter clock is faster than the receiver clock.

8. The apparatus of claim 7 wherein the processing system is further configured to change the concealment length by a number of samples equal to the accumulation of the differences less a threshold or a maximum number of samples, whichever is less.

9. The apparatus of claim 6 wherein the processing system is further configured to modify the data by either inserting or deleting one or more samples based on a polarity of the accumulation of the differences.

10. The apparatus of claim 6 wherein the processing system is further configured to modify the data if the accumulation of the differences exceeds a threshold.

11. The apparatus of claim 6 wherein the processing system is further configured to change the accumulation of the differences if the data is modified.

12. An apparatus for processing data, comprising:
a receiver clock; and
a processing system configured to use the receiver clock to receive data from a transmitter, the data being generated with a transmitter clock in the transmitter, wherein the processing system is further configured to estimate a mismatch between the transmitter and receiver clocks, determine a concealment length for a portion of the data based on a decoding error, and change the concealment length if the estimated clock mismatch satisfies one or more criteria.

13. The apparatus of claim 12 wherein the one or more criteria include the estimated clock mismatch indicating that the transmitter clock is faster than the receiver clock.

14. The apparatus of claim 12 wherein the one or more criteria include the estimated clock mismatch exceeding a threshold.

15. The apparatus of claim 12 wherein the data comprises one or more blocks of samples, the processing system being further configured to estimate the mismatch by computing a difference between the number of receiver clock cycles and an expected number of receiver clock cycles for each of the one or more blocks, and accumulating the computed differences.

16. The apparatus of claim 15 wherein the one or more criteria comprise the accumulation of the differences exceeding a threshold and indicating that the transmitter clock is faster than the receiver clock.

17. The apparatus of claim 16 wherein the processing system is further configured to change the concealment length by a number of samples equal to the accumulation of the differences less a threshold or a maximum number of samples, whichever is less.

18. A method for processing data, comprising:
receiving data from a transmitter by utilizing a receiver clock, the data being generated with a transmitter clock in the transmitter;
estimating a mismatch between the transmitter and receiver clocks; and
determining whether to modify the data based on the estimated mismatch.

19. The method of claim 18 further comprising determining a concealment length for a portion of the data based on a decoding error, and changing the concealment length if the estimated clock mismatch satisfies one or more criteria.

20. The method of claim 18 further comprising modifying the data by inserting additional data if the estimated mismatch satisfies one or more criteria including an indication that the receiver clock is faster than the transmitter clock.

21. The method of claim 18 further comprising modifying the data by deleting a portion of the data if the estimated mismatch satisfies one or more criteria including an indication that the transmitter clock is faster than the receiver clock.

22. The method of claim 18 further comprising modifying the data if the estimated mismatch exceeds a threshold.

23. The method of claim 18 wherein the data comprises one or more blocks of samples, the method further comprising estimating the mismatch by computing a difference between the number of receiver clock cycles and an expected number of receiver clock cycles for each of the one or more blocks, and accumulating the computed differences.

24. The method of claim 23 further comprising determining a concealment length for a portion of the data based on a decoding error, and changing the concealment length if the accumulation of the differences exceeds a threshold and indicates that the transmitter clock is faster than the receiver clock.

25. The method of claim 24 further comprising changing the concealment length by a number of samples equal to the accumulation of the differences less a threshold or a maximum number of samples, whichever is less.

26. The method of claim 23 further comprising modifying the data by either inserting or deleting one or more samples based on a polarity of the accumulation of the differences.

27. The method of claim 23 further comprising modifying the data if the accumulation of the differences exceeds a threshold.

28. The method of claim 23 further comprising changing the accumulation of the differences if the data is modified.

29. A method for processing data, comprising:
receiving data from a transmitter by utilizing a receiver clock, the data being generated with a transmitter clock in the transmitter;
estimating a mismatch between the transmitter and receiver clocks;
determining a concealment length for a portion of the data based on a decoding error; and
changing the concealment length if the estimated clock mismatch satisfies one or more criteria.

30. The method of claim 29 wherein the one or more criteria include the estimated clock mismatch indicating that the transmitter clock is faster than the receiver clock.

31. The method of claim 29 wherein the one or more criteria include the estimated clock mismatch exceeding a threshold.

32. The method of claim 29 wherein the data comprises one or more blocks of samples, the method further comprising estimating the mismatch by computing a difference between the number of receiver clock cycles and an expected number of receiver clock cycles for each of the one or more blocks, and accumulating the computed differences.

33. The method of claim 32 wherein the one or more criteria comprise the accumulation of the differences exceeding a threshold and indicating that the transmitter clock is faster than the receiver clock.

34. The method of claim 33 further comprising changing the concealment length by a number of samples equal to the accumulation of the differences less a threshold or a maximum number of samples, whichever is less.

35. An apparatus for processing data, comprising:
means for receiving data from a transmitter by utilizing a receiver clock, the data being generated with a transmitter clock in the transmitter;
means for estimating a mismatch between the transmitter and receiver clocks; and
means for determining whether to modify the data based on the estimated mismatch.

36. The apparatus of claim 35 further comprising means for determining a concealment length for a portion of the data based on a decoding error, and means for changing the concealment length if the estimated clock mismatch satisfies one or more criteria.

37. The apparatus of claim 35 further comprising means for modifying the data by inserting additional data if the estimated mismatch satisfies one or more criteria including an indication that the receiver clock is faster than the transmitter clock.

38. The apparatus of claim 35 further comprising means for modifying the data by deleting a portion of the data if the estimated mismatch satisfies one or more criteria including an indication that the transmitter clock is faster than the receiver clock.

39. The apparatus of claim 35 further comprising means for modifying the data if the estimated mismatch exceeds a threshold.

40. The apparatus of claim 35 wherein the data comprises one or more blocks of samples, the apparatus further comprising means for estimating the mismatch by computing a difference between the number of receiver clock cycles and an expected number of receiver clock cycles for each of the one or more blocks, and accumulating the computed differences.

41. The apparatus of claim 40 further comprising means for determining a concealment length for a portion of the data based on a decoding error, and means for changing the concealment length if the accumulation of the differences exceeds a threshold and indicates that the transmitter clock is faster than the receiver clock.

42. The apparatus of claim 41 further comprising means for changing the concealment length by a number of samples equal to the accumulation of the differences less a threshold or a maximum number of samples, whichever is less.

43. The apparatus of claim 40 further comprising means for modifying the data by either inserting or deleting one or more samples based on a polarity of the accumulation of the differences.

44. The apparatus of claim 40 further comprising means for modifying the data if the accumulation of the differences exceeds a threshold.

45. The apparatus of claim 40 further comprising means for changing the accumulation of the differences if the data is modified.

46. An apparatus for processing data, comprising:
means for receiving data from a transmitter by utilizing a receiver clock, the data being generated with a transmitter clock in the transmitter;
means for estimating a mismatch between the transmitter and receiver clocks;
means for determining a concealment length for a portion of the data based on a decoding error; and
means for changing the concealment length if the estimated clock mismatch satisfies one or more criteria.

47. The apparatus of claim 46 wherein the one or more criteria include the estimated clock mismatch indicating that the transmitter clock is faster than the receiver clock.

48. The apparatus of claim 46 wherein the one or more criteria include the estimated clock mismatch exceeding a threshold.

49. The apparatus of claim 46 wherein the data comprises one or more blocks of samples, the apparatus further comprising means for estimating the mismatch by computing a difference between the number of receiver clock cycles and an expected number of receiver clock cycles for each of the one or more blocks, and accumulating the computed differences.

50. The apparatus of claim 49 wherein the one or more criteria comprise the accumulation of the differences exceeding a threshold and indicating that the transmitter clock is faster than the receiver clock.

51. The apparatus of claim 50 further comprising means for changing the concealment length by a number of samples equal to the accumulation of the differences less a threshold or a maximum number of samples, whichever is less.

52. A computer program product for processing data, comprising:
a computer-readable medium encoded with instructions executable to:
receive data from a transmitter by utilizing a receiver clock, the data being generated with a transmitter clock in the transmitter;
estimate a mismatch between the transmitter and receiver clocks; and
determine whether to modify the data based on the estimated mismatch.

53. A computer program product for processing data, comprising:
a computer-readable medium encoded with instructions executable to:
receive data from a transmitter by utilizing a receiver clock, the data being generated with a transmitter clock in the transmitter;
estimate a mismatch between the transmitter and receiver clocks;
determine a concealment length for a portion of the data based on a decoding error; and
change the concealment length if the estimated clock mismatch satisfies one or more criteria.

54. A headset comprising:
a receiver clock;
a processing system configured to use the receiver clock to receive data from a transmitter, the data being generated with a transmitter clock in the transmitter, wherein the processing system is further configured to estimate a mismatch between the transmitter and receiver clocks, and to determine whether to modify the data based on the estimated mismatch; and
a transducer configured to provide an audible output based on the data.

55. A headset comprising:
a receiver clock;
a processing system configured to use the receiver clock to receive data from a transmitter, the data being generated with a transmitter clock in the transmitter, wherein the processing system is further configured to estimate a mismatch between the transmitter and receiver clocks, determine a concealment length for a portion of the data based on a decoding error, and change the concealment length if the estimated clock mismatch satisfies one or more criteria; and
a transducer configured to provide an audible output based on the data.

56. A watch comprising:
a receiver clock; and
a processing system configured to use the receiver clock to receive data from a transmitter, the data being generated with a transmitter clock in the transmitter, wherein the processing system is further configured to estimate a mismatch between the transmitter and receiver clocks, and to determine whether to modify the data based on the estimated mismatch; and
a display configured to provide a visual output based on the data.

57. A watch comprising:
a receiver clock;
a processing system configured to use the receiver clock to receive data from a transmitter, the data being generated with a transmitter clock in the transmitter, wherein the processing system is further configured to estimate a mismatch between the transmitter and receiver clocks, determine a concealment length for a portion of the data based on a decoding error, and change the concealment length if the estimated clock mismatch satisfies one or more criteria; and
a user interface configured to provide an indication based on the data.

58. A medical monitor comprising:
a receiver clock;
a processing system configured to use the receiver clock to receive data from a sensor, the data being generated with a transmitter clock in the sensor, wherein the processing system is further configured to estimate a mismatch between the sensor and receiver clocks, and to determine whether to modify the data based on the estimated mismatch; and
a display configured to provide a visual output based on the data.

59. A medical monitor comprising:
a receiver clock;
a processing system configured to use the receiver clock to receive data from a sensor, the data being generated with a transmitter clock in the sensor, wherein the processing system is further configured to estimate a mismatch between the transmitter and receiver clocks, determine a concealment length for a portion of the data based on a decoding error, and change the concealment length if the estimated clock mismatch satisfies one or more criteria; and
a display configured to provide a visual output based on the data.
